(19) United States
(12) Patent Application Publication
(10) Pub. No.: US 2019/0096279 A1
(43) Pub. Date: Mar. 28, 2019

(54) DECISION-MAKING SYSTEM USING EMOTION AND COGNITION INPUTS

(71) Applicant: Cerekinetic, Inc., Edmonds, WA (US)

(72) Inventor: Michael P.H. Lau, Edmonds, WA (US)

(21) Appl. No.: 16/141,731

(22) Filed: Sep. 25, 2018

Related U.S. Application Data
(60) Provisional application No. 62/563,541, filed on Sep. 26, 2017.

(51) Int. Cl. G09B 19/00

(52) U.S. Cl. CPC G09B 19/00

(57) ABSTRACT

A method and system for assessing an influence of emotion and cognition components on a decision-making process includes positioning a plurality of sensors with respect to a person and using the plurality of sensors to measure a physiologic condition of the person. A computational device quantifies one or more parameters representative of an emotion state and a cognition or memory utilization effort of the person before and during a decision-making process based on a sensed physiologic condition of the person, and further determines a relative influence of emotion versus cognition or memory utilization effort in the decision-making process based on the one or more quantified parameters representative of the emotion state and cognition or memory utilization effort of the person. The sensors may be attached to or embedded in a headgear or headset that is placed on the person's head to measure the physiologic condition of the person.

### BACKGROUND

### Technical Field

The present disclosure pertains to use of sensors, signal processing, and analytic algorithms to assess a person's physiological conditions and contribution thereof to a decision-making process.

### Description of the Related Art

Decision-making is a highly developed mental ability in humans. While we all make many decisions throughout life, some important or complicated, while others trivial or easy, the process of decision-making is rather complex, involving cognition and memory utilization, and is certainly influenced by emotion. Most persons have one time or other experienced a phenomenon of being “too angry to speak” or “mumbling nonsense while too excited in trying to impress.” These are examples of instances where emotion was possibly overcoming cognition, and affecting speech. It is well known that emotions affect humans while making economic decisions, often against sound financial principles and reasons. Behavioral economics and behavioral finance are disciplines studying the effects of emotion and behavior on economic activities such as investment, consumer preference, or marketing. Emotion certainly affects our decision over important issues in our lives—marriage and relationships, job and school, or where to settle, for example. It would be ideal if humans could make rational decisions without being influenced by, or worse overcome with, emotions. If unable to achieve this ideal, it would still be of value if one could recognize the contribution of emotion in the decision-making process, therefore enabling one to re-evaluate the validity of the decision.

### BRIEF SUMMARY

In at least one aspect, the present disclosure describes a method for assessing an influence of emotion and cognition components on a decision-making process includes positioning a plurality of sensors with respect to a person and using the plurality of sensors to measure a physiologic condition of the person. A computational device quantifies one or more parameters representative of an emotion state and a cognition or memory utilization effort of the person before and during a decision-making process based on a sensed physiologic condition of the person. A relative influence of emotion versus cognition or memory utilization effort in the decision-making process is determined based on the one or more quantified parameters representative of the emotion state and cognition or memory utilization effort of the person. The plurality of sensors may be attached to or embedded in a headgear or headset that is placed on the person's head to measure the physiologic condition of the person. In various embodiments, the plurality of sensors measure electroencephalogram (EEG) signals of the person.

In at least one embodiment, the computational device quantifies at least one parameter representative of the person's emotion state based on a measure of frontal asymmetry in which alpha band power detected in a left frontal region of the person is compared to alpha band power detected in a right frontal region of the person. The measure of frontal asymmetry indicates a measure of left-sided activation, and a left-sided activation that is greater during the decision-making than before the decision-making indicates a greater influence of emotion on the decision-making process.

In at least one embodiment, the computational device quantifies at least one parameter representative of the person's emotion state based on a measure of theta band power in an anterior region of the person compared to theta band power in a frontal midline region of the person.

In at least one embodiment, the computational device quantifies at least one measure representative of the person's cognition or memory utilization effort based on a measure of alpha band and theta band power in which a tonic increase in alpha band power and a decrease in theta band power occurs in combination with a large phasic decrease in alpha band power and increase in theta band power.

In at least one embodiment, the computational device quantifies at least one measure representative of the person's cognition or memory utilization effort utilizing a theta band and alpha band spectral power measures in which a theta band power peak in the frontal independent component (IC) signal, and an alpha band power peak in the central medial, motor, parietal, and occipital IC signals indicate increased cognition and memory utilization effort and therefore greater influence of a cognition component on the decision-making process.

A parameter representative of an emotion state may be an Emotion Dimension Index (EDI) in which the computational device quantifies EDI at a baseline state before the decision-making process and then quantifies EDI during the decision-making process. A ratio of change of EDI may be quantified by subtracting the EDI at the baseline state from the EDI during the decision-making process and dividing the result by the EDI at the baseline state.

A parameter representative of a cognition or memory utilization effort may be a Cognition Memory Dimension Index (CMDI) in which the computational device quantifies CMDI at a baseline state before the decision-making process and then quantifies CMDI during the decision-making process. A ratio of change of CMDI may be quantified by subtracting the CMDI at the baseline state from the CMDI during the decision-making process and dividing the result by the CMDI at the baseline state. Determining the relative influence of emotion versus cognition or memory utilization effort in the decision-making process may include calculating a difference between the Emotion Dimension Index (EDI) and the Cognition Memory Dimension Index (CMDI).

In at least one embodiment, the plurality of sensors further includes sensors that measure at least one of electrocardiogram (ECG) signals, heart rate, perspiration, or galvanic skin response (GSR) signals of the person. The computational device may quantify at least one parameter representative of the person's emotion state by determining a change in the person's ECG signals, heart rate, perspiration, or GSR signals from before the decision-making process to during the decision-making process. Alternatively or in addition, an aggregated Emotion Dimension Index (aEDI) may be calculated based on a weighted combination of the person's ECG signals, heart rate, perspiration, or GSR signals of the person with the person's EEG signals.

In various embodiments, the decision-making process may involve making multiple binary decisions organized in one or more decision trees.

The present disclosure further describes a system for assessing an influence of emotion and cognition components on a decision-making process. In at least one embodiment, the system includes an input subsystem comprised of a plurality of sensors that are positionable with respect to a person. The sensors are configured to measure a physiologic condition of the person. The system further includes an analytic subsystem comprised of a computational device configured to quantify one or more parameters representative of an emotion state and a cognition or memory utilization effort of the person before and during a decision-making process based on a sensed physiologic condition of the person. The computational device is further configured to determine a relative influence of emotion versus cognition or memory utilization effort in the decision-making process using the one or more quantified parameters representative of the emotion state and cognition or memory utilization effort of the person.

In at least one embodiment, the plurality of sensors are attached to or embedded in a headgear or headset configured to be placed on a person's head to measure the physiologic condition of the person.

In at least one embodiment, the system further comprises a guidance subsystem having a display device configured to display one or more results determined by the analytic subsystem. Alternatively or in addition, the guidance subsystem may be configured to provide feedback perceptible to the person that helps the person change their emotion and/or cognitive state, wherein the feedback changes in accordance with a change in the person's emotion and/or cognitive state.

Alternatively or in addition, the guidance subsystem may be configured to communicate one or more results determined by the analytic subsystem to a networked output for combination with one or more results for other persons using a same system to facilitate group decision-making.

### BRIEF DESCRIPTION OF THE SEVERAL VIEWS OF THE DRAWINGS

FIG. 1 is a schematic drawing of a system configured to receive sensor input that measures objective physiologic conditions of a person, quantifies one or more parameters representative of the person's emotion state and cognition/memory utilization effort, and based on the one or more quantified parameters, guides the person in a decision-making process.

FIG. 2A is a schematic drawing of a side view of a headset embedded with EEG sensors positioned over locations as labeled on a person's head.

FIG. 2B is a schematic drawing of a top view of the headset on the person's head as shown in FIG. 2A, and indicting the locations of the EEG sensors as labeled.

### DETAILED DESCRIPTION

The present disclosure contributes to optimizing decision-making for a person or a group of persons. Sensors, signal processing, and analytic algorithms are used to assess an emotion component and a cognition/memory utilization effort component during a decision-making process, and to quantify the relative influence of each component contributing to the decision-making process. The assessment of such can help guide the decision maker to evaluate and optimize the decision-making process. This technology disclosed herein can be applied to decision-making in life issues, marketing, consumer preference, investment and financial decisions, and other social and economic applications.

Neuroscience has shown that most of cognition and memory utilization functions take place in the neocortex, the most highly evolved part of the brain. Emotion, on the other hand, is believed to be mostly processed in the midbrain region. There are certain neuro-pathways and neuro-processes, originating from the midbrain, that relate emotion and its effects to influence cognition and memory utilization processes in the neocortex. The utilization of these neuro-pathways and neuro-processes generates electric potential signals that can be captured by electroencephalogram (EEG) sensors from the surface of the head. The changes of emotional state as processed in the midbrain also affect the functions at the brainstem, affecting the heart rate, respiratory effort, and autonomic nervous parameters, such as perspiration and skin conduction for example. These effects can also be measured with sensors such as electrocardiogram (ECG) sensors and galvanic skin response (GSR) sensors on the skin surface.

The physiologic sensors described herein, such as EEG, ECG, and GSR sensors, have been used in the same traditional way for decades. Recently, there are several technology innovations that can be used to improve these sensors. The sensors and the electronics can be integrated, miniaturized, and embedded in polymer patches to make them flexible. Innovative electronics, signal-capture and signal processing technologies enable the sensors to be used non-contact to the skin, requiring no conductive gel or pad. These advanced, flexible, non-contact sensors, such as those for EEG or ECG as examples, can be embedded in regular daily wear, to collect EEG or ECG data inconspicuously and comfortably from a person.

With advances in mobile wireless technologies and cloud computing, signal processing and analysis can be done with increasing complexity and sophistication, including the use of artificial intelligence and machine learning. These innovations open new possibilities in the use of physiologic data, for example EEG and ECG data, in clinical and consumer applications. As an example, most studies using EEG on emotion, cognition, and decision-making were performed using the traditional laboratory-based EEG devices, which tend to be cumbersome, non-mobile and clinical. With mobile, wearable EEG sensors, and wireless technology connecting these sensors to a computer, mobile device, or computing processes available in the cloud, powerful analytics can be performed to study a person's emotion, cognition, and decision-making while the person is performing his/her normal-life jobs and functions. The present disclosure uses advanced technologies described to create a novel system to optimize decision-making. This technology disclosed herein can be applied to decision-making in life issues, marketing, consumer preference, investment and financial decisions, and other social and economic applications.

Disclosed herein is a decision-making system that assesses the relative influence of an emotion component versus a cognition component of a person in a decision-making process by the person. The assessment of these components on the person making the decision is performed by evaluating the person's neurophysiologic and biophysiologic measures quantitatively. The outcomes of the assessment can be used to guide the person in making a more optimal decision.

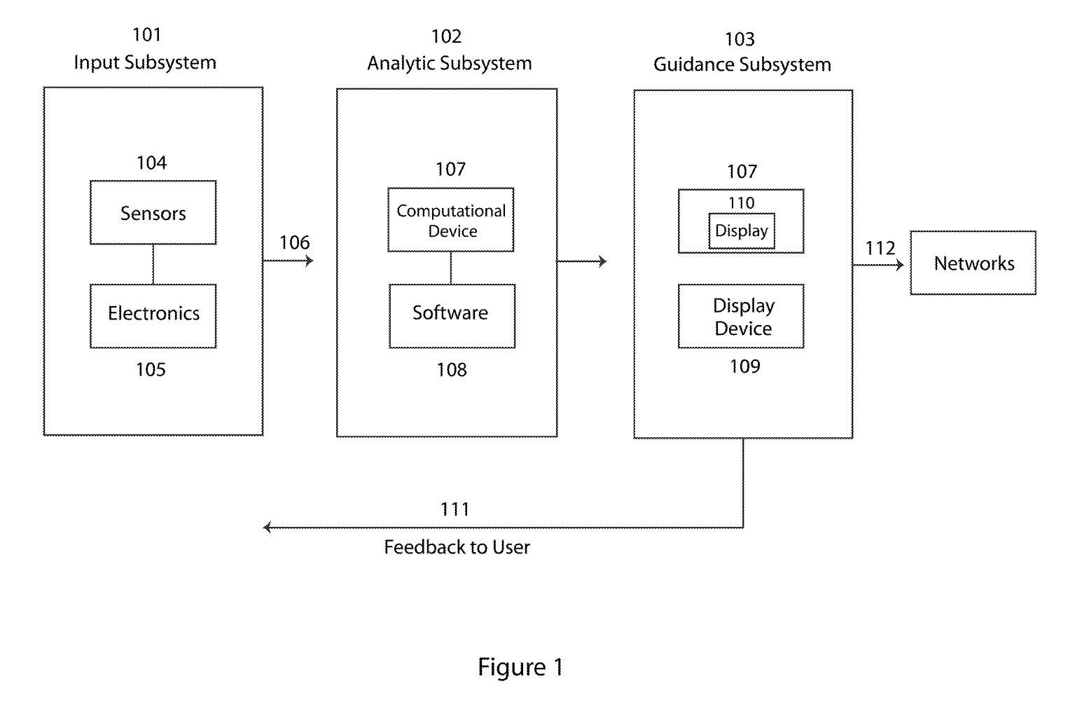

An embodiment of a decision-making system is illustrated in FIG. 1 and comprises an input subsystem 101 that provides a measurement of neurophysiologic and biophysiologic conditions in a person related to emotion and cognition components of the person as inputs to an analytic subsystem 102. The analytic subsystem 102 quantifies and analyzes the emotion and cognition components and outputs analytic results to a guidance subsystem 103. The guidance system displays some or all of the analytic results to provide guidance to the person in the decision-making process, with an option to provide a feedback mechanism to automate the optimization of the decision-making process. There is also an option to network with other users in making a group decision.

The input subsystem 101 comprises sensors 104 configured to measure a plurality of neurophysiologic and biophysiologic parameters of a person. For example, these sensors may be configured to detect and measure electroencephalogram (EEG) signals, electrocardiogram (ECG) signals, heart rate, skin perspiration, galvanic skin response (GSR) signals, electromechanical signals of the person, and/or optical pulse oximetry signals. The sensors may be in contact or not in contact to the person's skin. Depending on the particular sensors and the desired parameters to be measured, the sensor may or may not require a conductive medium. The sensors may be rigid or flexible. The sensors may be embedded in patches or positioned in clothing that are wearable. The input subsystem 101 comprises also electronic circuits 105 for power supply and possibly signal processing, and for data transmission 106 including wireless or hardwire communication options.

The analytic subsystem 102 includes computational devices 107 having programmable processing circuitry such as, for example, a computer, a mobile device including a mobile pad, a phone, a smart watch, or a computing cloud system, and processing software 108 including for example one or more computational and/or analytic algorithms. The software 108 may comprise executable instructions that are stored in a computer-readable memory communicatively coupled to a processor 107. The processor 107 executing the instructions implements the algorithms to analyze the signal data received by the processor 107 from the sensors 104 and produce one or more outputs that may be, for example, shown on a display also communicatively coupled to the processor. The analytic subsystem 102 may further include an artificial intelligence algorithm that is teachable through machine learning to suggest recommendations regarding the person's current decision made based on information learned from the user's past decision-making patterns, the decisions made, and their outcome. The parameters to be quantified and analyzed represent the emotion component and the cognition component, including cognition and memory utilization effort, of the person's neural processes during the decision-making, as indicated by physiological signals sensed by sensors 104 positioned on or near the person.

The guidance subsystem 103 comprises a display device that is independent of (109), or as part of (110) the computational device 107 being used in the analytic subsystem 102, to display relevant data collected, analytic results, and/or recommendations. Wired or wireless communication connections may be used to provide feedback 111 from the guidance subsystem 103 to the person making the decision or to one or more networks 112 of other users to optimize the decision-making process of the person or a group of persons.

One example of the input subsystem 101 comprises electroencephalogram (EEG) sensors 104 being deployed in a standard configuration for multichannel communication, using for example, 32, 64, 128 or 256 electrodes with placement utilizing the standard 10-5, 10-10, or 10-20 systems. Independent Component Analysis (ICA) can be used to process the EEG signals acting as spatial filters to specify distinct information source(s) in the recorded multichannel data. This EEG setup can capture and provide extensive EEG data relating to temporal and spatial information needed for analysis to quantify and assess measures of the person's emotion and cognition components. However, these types of standard EEG devices with a high number of channels have bulky, conspicuous headgear and typically require use with conductive gel or pads. In many instances, such an EEG setup is too cumbersome, highly non-mobile, and labor intensive to use, and therefore is usually confined to a clinical or laboratory setting.

For some embodiments of the present disclosure, it is valuable to devise a system for use by a person outside such a clinical or laboratory setting, to optimize a decision-making process that is applicable to the many economic, investment, financial commitments, consumer choices and daily-life decisions of the person. Optimizing a decision-making process comprises assisting a user (e.g., by instruction or other feedback) to limit the emotion component contributing to the decision and to emphasize or increase the cognition and memory utilization effort component, to make a rational decision.

To enable use of the decision-making system in a more realistic, mobile, daily-living setting, specific configurations of smaller numbers of EEG sensors may be placed over specific positions on the person's head. The sensors are designed and positioned to capture the desired temporal and spatial EEG information to measure objective physiologic conditions of the person. The measured conditions are then used to quantify parameters representative of the person's emotion state and cognition/memory utilization effort, and based on the quantified parameters, guide the person in a decision-making process.

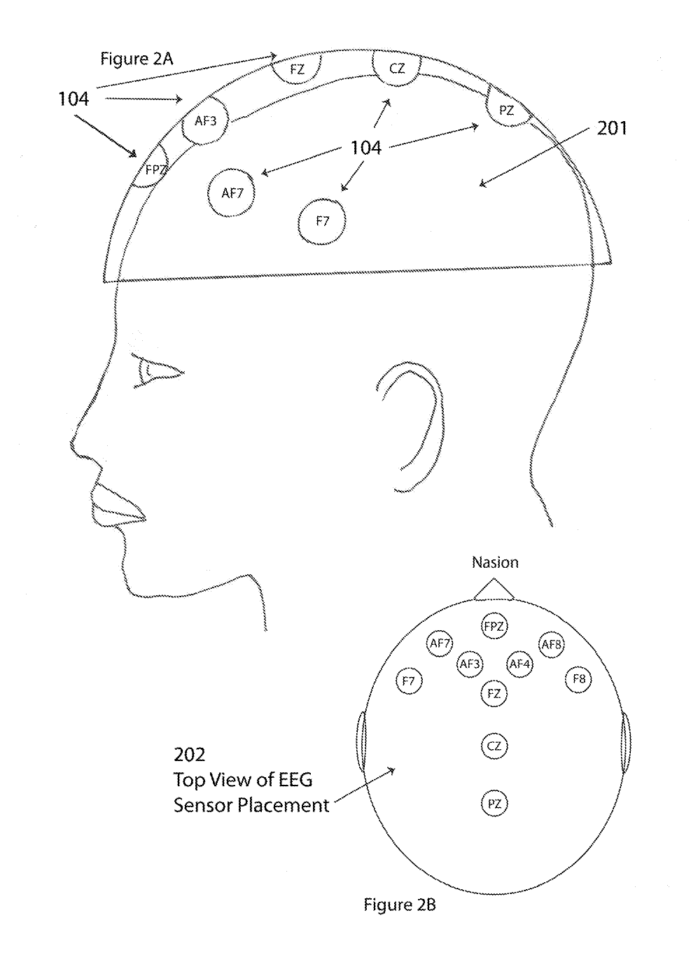

In above-noted non-limiting example, the EEG sensors 104 are positioned in a headset 201 placed on the head of the person, as illustrated in FIGS. 2A and 2B. In some cases, the headset 201 may be configured as a wearable hat. The EEG sensors 104 detect EEG signals from the brain over certain locations of the head in specific configurations, for example but not limited to the one illustrated in FIG. 2A. For this example, ten EEG sensors 104, which can be contact or non-contact in type, are embedded in the headset 201 over the specific positions of, for example, FPZ, FZ, CZ, PZ, AF3, AF7, F7, AF4, AFB, and F8 shown in top view 202 of FIG. 2B, as per a standard defined location for each, covering the frontal and midline regions which are of specific interest in this example. Other example setups may include EEG sensors, of different numbers, over different locations on the head, not limited to the frontal and midline regions as stated in the previous example, as designed to optimize the capture of EEG information from the person. The EEG signals detected by the sensors are transmitted to electronic circuits 105 in the headset or hat to be processed, for example digitized and/or amplified, and transmitted 196 through a wire, or wirelessly, to the computational device 107 of the analytic subsystem 102, for further processing and analysis with analytic algorithms in the software 108. Machine learning, artificially intelligent algorithms may be implemented as part of the processes for analysis drawing from the user's past history (sensed inputs and decision outcomes) in the course of helping the user optimize present decision-making.

Further specifications may be applied to the detected signals in the EEG bands to be studied in those specific locations, for example but not limited to, the theta and alpha bands. These specifications are used to optimize the EEG data collection in performing certain specific tasks, for example, measuring emotion or cognition and memory utilization effort, to be described below. Since the number of EEG sensors needed are limited, as tailored to the specific need of EEG information location and spectrum to be studied, the headgear 201 for such can be much more non-obtrusive, inconspicuous, and tolerable. Using non-contact EEG sensors and wireless electronics with this example, the sensors may be embedded in a hat or other regular headwear without the need for conductive gel or pads, making it acceptable as a regular wearable item while performing decision making in a daily living and work setting, outside of a laboratory or clinic.

Several processes may be used to quantify and analyze parameters representative of the emotion state of the person being studied, based on the EEG data and possibly other physiologic measures. One non-limiting example utilizes measures of EEG alpha band power (8-13 Hz band) to estimate “frontal asymmetry,” which contrasts alpha band power in the left frontal region with alpha band power of the right frontal region. Traditionally, greater left-sided activation infers to more positive emotional valence (Tomarken 1990). Other studies have showed that frontal asymmetry indicating greater left-sided activation was linked to dispositional tendencies toward approach (vs. avoidance) (Sutton 1997) and anger emotion (Harmon-Jones 2006). Without specifying any particular “emotion,” analysis of the alpha EEG band power in the left and right frontal regions using the process of frontal asymmetry, for example, and identifying greater left-sided activation can indicate a greater emotion state as a “dimension”—the emotion dimension. In this example, a baseline level of frontal asymmetry of the person being studied can be measured. The person then goes through a decision-making process and the level of frontal asymmetry is evaluated during the decision-making process. The change in the level of the emotion dimension can be derived and quantified by the measurement of frontal asymmetry.

Other algorithms employing EEG measures to gauge the level of the emotion dimension may be utilized. For example, it has been shown that subjective scores of emotional experiences significantly correlated with theta band power in the anterior and frontal midline region (Aftanas 2001). As specific EEG measures are developed and used to quantify emotion, the specific EEG sensor placement locations and EEG bands being studied can be specified and tailored to optimize the data collection in the most relevant, effective and convenient way as described previously. As stated, examples may utilize non-contact EEG sensors embedded in a wearable hat, without the need of conduction gel or saline pad, over specific regions of the head, for example the frontal and midline regions, or the anterior and midline regions, to collect theta and or alpha band EEG signals for processing and analysis to quantifiably measure the person's emotional state as illustrated in examples given. In yet another alternative implementation for example, a 64 channel standard EEG contact electrode system can be used to collect EEG signals from the person being studied, and the system may use ICA to process the EEG data from the specific information source (sensor) locations and EEG bands to provide the needed information to measure the person's emotion state using, for example, alpha band frontal asymmetry and theta band power from the frontal, midline, and/or anterior regions. Based on the present disclosure, further examples can be implemented using specific information (EEG data) gained from source locations (sensors) and EEG band markers relating to the person's emotion state from multi-channel ICA studies and large scale mobile EEG studies. These examples leverage the information gained to tailor make the headwear with even fewer EEG sensors, making the headwear even more user friendly for the consumer market.

The emotion state measured in the above-described examples is more of emotion as a dimension instead of a state of a specific emotion, such as fear, sadness, joy, or greed for example. Using emotion as a dimension simplifies the assessment and the quantification process of emotion. Other examples can measure sensor signals, for example but not limited to EEG signals, indicative of a specific emotion such as pleasure or use an approach associated with left-sided activation in frontal asymmetry EEG studies, or similarly a specific emotion of negative valence or avoidance associated with right-sided activation in frontal asymmetry EEG studies. With analytic and possibly artificially intelligent algorithms as described herein, a specific emotion state, such as for example, fear, can be used to evaluate the person's decision-making in, for example, equity investments, employing the analytic processes illustrated by the examples described in the analytic sections below.

The person's cognition and/or memory utilization effort dimension can likewise be evaluated by analyzing EEG data according to known EEG studies. It has been demonstrated that EEG alpha and theta oscillations reflect cognitive and memory performance (Klimesch 1999). For example, good cognitive and memory performance is related to a tonic increase in alpha band power but a decrease in theta band power, and a large phasic (event-related) decrease in alpha band power but increase in theta band power. Another example is using ICA on high-density EEG data, e.g., as used in a study of simulated air traffic control tasks. In this case, five EEG independent component (IC) signals were found associated with specific neural substrates, specifically, the frontal, central medial, motor, parietal, and occipital areas (Dasari 2017). The theta spectral power of the frontal IC and the alpha band power of the four other ICs, were detected to be correlated to mental work load and effort level.

Another non-limiting example that assesses cognition effort using a standard method of collecting EEG data with the standard placements of EEG electrodes, in conjunction with ICA for processing, to provide the EEG data to measure cognition and/or memory effort, utilizes the theta and alpha spectral power measures of the ICs as described by Dasari above (Dasari 2017). In this example, the theta band power peak in the frontal IC, and alpha band power peak in the central medial, motor, parietal, and occipital ICs, are interpreted as being associated with increased cognition and memory utilization effort.

Another non-limiting example uses non-contact EEG sensors embedded in a wearable hat, without the need of conduction gel or saline pad, over specific regions of the head, for example the frontal and midline, to collect theta and alpha band EEG signals for processing and analysis to measure cognition and memory performance by studying the alpha and theta oscillations as described by Klimesch (Klimesch 1999). As specific EEG measures are developed and used to quantify cognition and/or memory utilization efforts, the specific EEG sensor placements and EEG bands being studied can be specified and tailored to optimize the data collection in the most relevant, effective and convenient way as described above, with the objective to make the sensor embedded headgear or headwear more user friendly and tolerable by reducing the number and size of sensors and electronics in the design while serving specifically the intended functions.

The analytic subsystem 102 receives the EEG data from the input subsystem 101, then uses a computational and/or analytic algorithm, which optionally may include artificial intelligence (i.e., that is teachable, using machine learning on past data and known outcomes) to compute and analyze the EEG data to derive the emotion component and the cognition component, including cognition and memory utilization effort, of the person's neural processes during the decision making.

As noted earlier, an example analytic process, for example, may utilize “frontal asymmetry,” which contrasts alpha band power in the left frontal region with alpha band power of the right frontal region, to measure the emotion dimension. For example, an increase in left sided activation could indicate a higher emotion state as explained earlier (Tomarken 1990, Sutton 1997, Harmon-Jones 2006). A quantitative measure based on the degree of left sided activation can be assigned to the emotion dimension, termed as an Emotion Dimension Index (EDI), as an example.

The cognition component can be measured by, for example, the fact that EEG alpha and theta oscillations reflect cognitive and memory performance (Klimesch 1999). A more specific example would be that good cognitive and memory performance is related to a tonic increase in alpha band power but a decrease in theta band power. A quantitative measure based on levels of EEG alpha and theta oscillations and/or an increase in alpha band power and decrease in theta band power can be assigned to the cognition/memory dimension, termed as a Cognition Memory Dimension Index (CMDI), as an example.

To estimate a change of the emotion dimension of the subject, the Emotion Dimension Index (EDI) of the person is first measured at a baseline state, e.g., at rest, before a decision-making process, for example termed as EDI(baseline). The person then begins the decision-making process. The EDI measured during the decision-making process is termed as EDI(decision). A ratio of change in the EDI, termed Δ EDI, may be calculated as EDI(decision)−EDI(baseline)/EDI(baseline), which can be positive or negative in numeric value, as shown in Formula 1.

ΔEDI=(EDI(decision)−EDI(baseline))/EDI(baseline) Formula 1:

To estimate a change of the cognition memory dimension of the subject, the Cognition Memory Dimension Index (CMDI) of the person is first measured at a baseline state, e.g., at rest, before a decision-making process, for example, termed as CMDI(baseline). The person then begins the decision-making process. The CMDI measured during the decision-making process is termed as CMDI(decision). A ratio of change in the CMDI, termed Δ CMDI, may be calculated as CMDI(decision)−CMDI(baseline)/CMDI(baseline), which can be positive or negative in numeric value, as shown in Formula 2.

ΔCMDI=(CMDI(decision)−CMDI(baseline))/CMDI(baseline) Formula 2:

In this example, the emotion component versus the cognition/memory utilization effort component during the specific decision-making process is evaluated by looking at the Δ EDI as compared with the Δ CMDI during the decision-making process. This quantified measure can be used qualitatively to assess the influence of the emotion component and/or the cognitive component in the decision-making process. Alternatively, a quantitative measure, for example, termed as the Emotion Cognition Differential (ECD), can be defined as the difference between Δ EDI and Δ CMDI, as shown in Formula 3.

ECD=ΔEDI−ΔCMDI Formula 3:

A higher, more positive ECD would indicate a larger emotion component in the decision-making process, more dominating than the cognition and memory utilization effort component. In other words, quantitatively, a higher, more positive ECD implies a greater influence of emotion in the person's decision-making process.

Another example for assessing the emotion component of the person, in addition to using EEG, includes using heart rate (HR), ECG, skin perspiration, and/or GSR measures. These parameters can be measured by embedding or otherwise positioning the appropriate sensors into the headset, either separated from, or as part of the EEG sensors. For example, the non-contact EEG sensor may also be configured to detect measure ECG or heart rate, using signal processing known in the art to separate the cardiac signals from the EEG signals. Another non-limiting example uses an integrated contact sensor on the skin of the forehead that can measure EEG, ECG, heart rate and/or GSR.

A change in the person's physiologic parameters, such as an increase in heart rate, from a baseline measurement to a current measurement may be related to a greater emotion state, which can be quantified and contrasted as measured before and during the decision-making process. A change in these parameters is related to a change in the person's emotion state during the decision-making. In at least one example, these measures of change are used to augment the evaluation of EEG data, such as EDI for EEG measures—termed EDI(EEG), in assessing the change in the person's emotion state. Each of the components of the physiologic measures may be assigned a different weight in the assessment of the overall aggregated EDI. The aggregated EDI (aEDI) may be determined, for example, by a formula such as:

aEDI=EDI(EEG)+αHR+βGSR,

where α and β are the corresponding weight coefficients applied to measurements of the person's heart rate and galvanic skin response.

The aEDI may be used in place of EDI(EEG) to calculate the Δ EDI and the ECD as another iteration for assessment.

The guidance subsystem 103 comprises a display device 109 that is independent of, or as part 110 of the computational device 107 that is utilized in the analytic subsystem 102, to display relevant data obtained from the sensors, analytic results calculated therefrom, and/or recommendations based on the analytic results. The Δ EDI, Δ CMDI, and ECD information may be, for example, displayed on the device. The decision maker utilizes the information as provided to evaluate how relevant emotion has affected the decision made.

Another option is that the information—Δ EDI, Δ CMDI, and the ECD, is communicated via wired or wireless connections 112 to a network of other users utilizing the same type of devices and processes as to optimize the decision-making process functioning as a group, leveraging the effect of wisdom of crowds yet taking into account emotion considerations. For example, since each different user might have a different emotional reaction or be in a different emotion state when presented with a decision to be made, the aggregated emotion component measures in a group should usually be diversified down as a contribution to the decision-making. However, in certain situation when “mob” or “herd” emotion mentality might set in, the system would be able to differentiate that out as well by measuring an unusually high group emotion component.

Another non-limiting example comprises a wired or wireless connection 111 to transmit guidance information to provide feedback to the person making the decision. The guidance information may be in the form of electronic signals related to results derived by the guidance subsystem 103 from analysis by the analytic subsystem 102, e.g., Δ EDI, Δ CMDI, and the ECD, or processed signals from the source EEG information, such as for example, the degree of frontal asymmetry in the alpha band as related to emotional state, to be utilized in performing automated neuro-feedback to decrease the influence of emotion in the decision-making process. An example utilizing this principle to help train the brain using a neuro-feedback process to decrease the emotion component during the decision-making process could be, as an example, as follows. The processed signals relating to the degree of frontal asymmetry, corresponding to the person's emotion dimension state, would generate correlated graded audio tones output by the system via a speaker during the decision-making process. Hearing the audio tone, the user then, for example, employs breathing exercises to decrease the emotion dimension as indicated by a change in the audio tone through neuro-feedback. In other words, illustrated as an example, the user uses a breathing exercise to calm the emotion through neuro-feedback as reflected by hearing a decreasing audio tone indicating a less emotion state. This process helps to optimize the current decision-making process, and helps the user to apply such training to benefit future decision-making endeavors.

As for the types of decisions that can be assessed using the disclosed method and system, one non-limiting example involves binary decisions—yes or no; buy or sell; buy or hold; sell or hold; go or stay; and other similar decisions for example. The binary decision process would most likely allow generating relevant quantification of emotion and cognition/memory effort using a study of physiologic signals, such as EEG. Multiple choice/outcome decisions, such as choosing two stocks to invest in out of ten possible stocks, or choosing the best color for a dress out of five colors, in some situations makes the EEG information quantification less relevant or more difficult to assess. However, most multiple choice/outcome decisions can be reduced to relevant multiple binary decisions (sub-decisions). Another non-limiting example uses multiple binary decisions, in which each decision allows more relevant quantification of the physiologic (such as EEG) information, to enable the construction of a decision tree or trees based on the binary sub-decisions to derive the final multiple choice/outcome decision.

In view of the above, various non-limiting aspects of methods and systems described herein may be described, in part, as including a method and system used to optimize a person's decision-making process by assessing and utilizing the person's emotion state and cognition/memory effort measures derived from objective physiologic inputs from the person. Sensors measure physiologic parameters of the person that may include, for example but not limited to, electroencephalogram (EEG), electrocardiogram (ECG), heart rate, perspiration, or skin conduction (GSR) parameter, and transmit the physiologic information to a computational device. By using computational and analytic algorithms, the emotion state and the cognition/memory utilization effort of that person before and during the decision-making process can be quantified. Such information may be used to determine the relative influence of emotion versus cognition/memory utilization effort in the decision-making process, with the purpose to optimize the decision-making.

The sensors can be contact or non-contact in nature, flexible or rigid, and can capture a single type of physiologic information, for example EEG, or multiple types of physiologic information, for example EEG, ECG and heart rate. The sensors can be embedded in a headgear to be worn over a person's head and, in particular, can be non-contact sensors embedded in a regular headwear to be worn over the head without conductive medium. To the extent that EEG sensors are used, the EEG sensors can be configured in standard EEG positions. The EEG sensors can be configured in a specific pattern over the head designed to capture EEG signals from specific information locations and/or at specific EEG wave bands.

The physiologic information collected by the sensors can be wirelessly transmitted to a computational device. The computational device can include, for example, a computer, a mobile device including mobile pad, a phone and/or smart watch, or computing cloud. Computational and/or analytic algorithms implemented using the computational device can include artificial intelligence and machine-learning software.

The decision to be made can be binary in nature, and/or can be constructed using multiple binary decisions in the form of one or more decision trees. The results of the assessment and analysis can be displayed on the computational device or on an independent display device. The assessment outputs from the computational device can be networked with other users using the same type of device to perform group decision-making. The assessment outputs from the computational device can be used to enable neuro-feedback with the user.

The various embodiments described above can be combined to provide further embodiments. All of the U.S. patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### REFERENCES

Aftanas L I, Golocheikine S A. Human anterior and frontal midline theta and lower alpha reflect emotionally positive state and internalized attention: High-resolution EEG investigation of meditation. Neuroscience Letters. 2001; 310:57-60.
Dasari D, Shou G and Ding L. ICA-Derived EEG Correlates to Mental Fatigue, Effort, and Workload in a Realistically Simulated Air Traffic Control Task. Front. Neurosci. 2017; 11:297.
Harmon-Jones E, Lueck L, Fearn M, Harmon-Jones C. The effect of personal relevance and approach-related action expectation on relative left frontal cortical activity. Psychological Science. 2006; 17(5):434-440.
Klimesch, W. EEG Alpha and Theta Oscillations Reflect Cognitive and Memory Performance: A Review and Analysis. Brain Research Reviews. 1999; 29:169-195.
Sutton S K, Davidson R J. Prefrontal brain asymmetry: A biological substrate of the behavioral approach and inhibition systems. Psychological Science 1997; 8(3):204-210.
Tomarken A J, Davidson R J, Henriques J B. Resting frontal brain asymmetry predicts affective responses to films. Journal of Personality and Social Psychology. 1990; 59:791-801.

1. A method for assessing an influence of emotion and cognition components on a decision-making process, comprising:
positioning a plurality of sensors with respect to a person;
using the plurality of sensors to measure a physiologic condition of the person;
quantifying, by a computational device, one or more parameters representative of an emotion state and a cognition or memory utilization effort of the person before and during a decision-making process based on a sensed physiologic condition of the person; and
determining, by a computational device, a relative influence of emotion versus cognition or memory utilization effort in the decision-making process based on the one or more quantified parameters representative of the emotion state and cognition or memory utilization effort of the person.

2. The method of claim 1, wherein the plurality of sensors are attached to or embedded in a headgear or headset, the method further comprising placing the headgear or headset on the person's head to measure the physiologic condition of the person.

3. The method of claim 1, wherein using the plurality of sensors to measure a physiologic condition of the person includes using sensors that measure electroencephalogram (EEG) signals of the person.

4. The method of claim 3, wherein the computational device quantifies at least one parameter representative of the person's emotion state based on a measure of frontal asymmetry in which alpha band power detected in a left frontal region of the person is compared to alpha band power detected in a right frontal region of the person.

5. The method of claim 4, wherein the measure of frontal asymmetry indicates a measure of left-sided activation, and a left-sided activation that is greater during the decision-making than before the decision-making indicates a greater influence of emotion on the decision-making process.

6. The method of claim 3, wherein the computational device quantifies at least one parameter representative of the person's emotion state based on a measure of theta band power in an anterior region of the person compared to theta band power in a frontal midline region of the person.

7. The method of claim 3, wherein the computational device quantifies at least one measure representative of the person's cognition or memory utilization effort based on a measure of alpha band and theta band power in which a tonic increase in alpha band power and a decrease in theta band power occurs in combination with a large phasic decrease in alpha band power and increase in theta band power.

8. The method of claim 3, wherein the computational device quantifies at least one measure representative of the person's cognition or memory utilization effort utilizing a theta band and alpha band spectral power measures in which a theta band power peak in the frontal independent component (IC) signal, and an alpha band power peak in the central medial, motor, parietal, and occipital IC signals indicate increased cognition and memory utilization effort and therefore greater influence of a cognition component on the decision-making process.

9. The method of claim 3, wherein a parameter representative of an emotion state is a an Emotion Dimension Index (EDI) in which the computational device quantifies EDI at a baseline state before the decision-making process and then quantifies EDI during the decision-making process, the method further comprising quantifying a ratio of change of EDI by subtracting the EDI at the baseline state from the EDI during the decision-making process and dividing the result by the EDI at the baseline state.

10. The method of claim 9, wherein a parameter representative of a cognition or memory utilization effort is a Cognition Memory Dimension Index (CMDI) in which the computational device quantifies CMDI at a baseline state before the decision-making process and then quantifies CMDI during the decision-making process, the method further comprising quantifying a ratio of change of CMDI by subtracting the CMDI at the baseline state from the CMDI during the decision-making process and dividing the result by the CMDI at the baseline state.

11. The method of claim 10, wherein determining the relative influence of emotion versus cognition or memory utilization effort in the decision-making process includes calculating a difference between the Emotion Dimension Index (EDI) and the Cognition Memory Dimension Index (CMDI).

12. The method of claim 3, wherein using the plurality of sensors to measure a physiologic condition of the person further includes using sensors that measure at least one of electrocardiogram (ECG) signals, heart rate, perspiration, or galvanic skin response (GSR) signals of the person.

13. The method of claim 12, wherein the computational device quantifies at least one parameter representative of the person's emotion state by determining a change in the person's ECG signals, heart rate, perspiration, or GSR signals from before the decision-making process to during the decision-making process.

14. The method of claim 12, further comprising calculating an aggregated Emotion Dimension Index (aEDI) based on a weighted combination of the person's ECG signals, heart rate, perspiration, or GSR signals of the person with the person's EEG signals.

15. The method of claim 1, wherein the decision-making process involves making multiple binary decisions organized in one or more decision trees.

16. A system for assessing an influence of emotion and cognition components on a decision-making process, comprising:
an input subsystem that includes a plurality of sensors that are positionable with respect to a person, wherein the sensors are configured to measure a physiologic condition of the person; and
an analytic subsystem that includes a computational device configured to quantify one or more parameters representative of an emotion state and a cognition or memory utilization effort of the person before and during a decision-making process based on a sensed physiologic condition of the person, wherein the computational device is further configured to determine a relative influence of emotion versus cognition or memory utilization effort in the decision-making process using the one or more quantified parameters representative of the emotion state and cognition or memory utilization effort of the person.

17. The system of claim 16, further comprising a guidance subsystem having a display device that displays one or more results determined by the analytic subsystem.

18. The system of claim 16, further comprising a guidance subsystem configured to provide feedback perceptible to the person that helps the person change their emotion and/or cognitive state, wherein the feedback changes in accordance with a change in the person's emotion and/or cognitive state.

19. The system of claim 16, further comprising a guidance subsystem configured to communicate one or more results determined by the analytic subsystem to a networked output for combination with one or more results for other persons using a same system to facilitate group decision-making.

20. The system of claim 16, wherein the plurality of sensors are attached to or embedded in a headgear or headset configured to be placed on a person's head to measure the physiologic condition of the person.
